(19) United States
(12) Patent Application Publication
(10) Pub. No.: US 2024/0091772 A1
(43) Pub. Date: Mar. 21, 2024

(54) DEVICES AND METHODS FOR FLOW CONTROL IN A MICROFLUIDIC SYSTEM

(71) Applicant: TDK Corporation, Tokyo (JP)

(72) Inventor: Manish Giri, San Jose, CA (US)

(73) Assignee: TDK Corporation, Tokyo (JP)

(21) Appl. No.: 18/466,737

(22) Filed: Sep. 13, 2023

Related U.S. Application Data
(60) Provisional application No. 63/406,851, filed on Sep. 15, 2022.

(51) Int. Cl. B01L 3/00

(52) U.S. Cl. CPC B01L 3/502746; B01L 3/502707; B01L 2300/0645; B01L 2400/0439

(57) ABSTRACT

A microfluidic device and a method for flow control of cells or particles in a microfluidic channel are disclosed. The microfluidic device may include a substrate having an outlet channel. The microfluidic device may also include a microfluidic channel arranged on the substrate such that an outlet of the microfluidic channel is positioned above the outlet channel. The microfluidic device may further include a set of piezoelectric actuators arranged above the outlet channel and adjacent to the outlet, the set of piezoelectric actuators configured to eject a portion of a fluid out of the microfluidic channel via the outlet.

### PRIORITY AND RELATED APPLICATIONS

This application claims priority to U.S. Provisional Patent App. Ser. No. 63/406,851, filed Sep. 15, 2022, entitled “Thin film PZT actuator located in the microfluidic channel,” which is incorporated by reference herein in its entirety.

### TECHNICAL FIELD

This application relates generally to flow control of cells or particles, and more particularly to flow control of cells or particles in a microfluidic flow channel.

### BACKGROUND

Conventional techniques for flow control of cells or particles in microfluidic devices rely on external flow systems (e.g., using components located outside the microfluidic device). However, such an external flow control system typically does not provide precise control of the flow dynamics in the microfluidic device for reliable cell capture, localization, and analysis, and results in a system that is more complex and less cost-effective. These and other challenges associated with external flow control systems have limited the throughput for processing cells or particles using a microfluidic device.

### SUMMARY

As described above, controlled flow is a challenging problem in microfluidic devices. In some systems, external pumps are used for coarse flow control. In some systems, piezoelectric discs are attached to cause flow, or piezoelectric MEMS devices are attached for driving flow. However, cell flow dynamics are challenging to control with each of these approaches (e.g., due to a lack of process control and/or precision). Devices and methods for flow control in microfluidic devices or systems are described herein. Such devices and methods may address challenges associated with conventional devices and methods for flow control in microfluidic devices or systems.

For example, a single cell particle sensing system (e.g., for bacteria/viruses) with integrated electrodes and inertial piezoelectric pumps (that form a laminar flow field of single cells) is described. The piezoelectric pumps oscillations can create displacement as well as acoustic waves which control localized inertial movement of the particles (e.g., in the x, y and z planes) with sub-micron level control. Additionally, the piezoelectric material (e.g., lead zirconate titanate (PZT)) may be placed such that it is protected from any mechanical contact during processing or operation.

In accordance with some embodiments, a microfluidic device includes (i) a substrate having an outlet channel; (ii) a microfluidic channel arranged on the substrate such that an outlet of the microfluidic channel is positioned above the outlet channel; and (iii) a set of piezoelectric actuators arranged above the outlet channel and adjacent to the outlet, the set of piezoelectric actuators configured to eject a portion of a fluid out of the microfluidic channel via the outlet.

In accordance with some embodiments, a method includes (i) providing a plurality of particles through a microfluidic channel having an outlet positioned above an outlet channel; (ii) manipulating, with a set of electrodes, the particles flowing through the microfluidic channel with an electrical field; and (iii) ejecting, with a set of piezoelectric actuators located adjacent to the outlet and above the outlet channel, a portion of a fluid in the microfluidic channel.

In accordance with some embodiments, a method of constructing a microfluidic device includes (i) placing a set of piezoelectric actuators on a substrate; (ii) placing a passivation layer on the set of piezoelectric actuators; (iii) forming an outlet channel by removing a portion of the substrate below the set of piezoelectric actuators; (iv) placing a polymer layer on an optical layer (e.g., a glass substrate); (v) forming a microfluidic inlet by removing a portion of the optical layer; and (vi) forming a microfluidic channel between the microfluidic inlet and the outlet channel by coupling the optical layer to the substrate via the polymer layer.

Thus, the disclosed devices and methods relate to flow and ejection control techniques which are implemented within or as part of a microfluidic device, and allow controlling flow of cells or particles in a microfluidic flow channel based on electro-hydro-dynamic (EHD) displacement using piezoelectric actuators and electrodes. Such a controlled flow provides reliable cell capture, localization, and analysis. The disclosed devices and methods may replace, or complement, conventional devices and methods.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1A shows a plan view of an example microfluidic device in accordance with some embodiments.

FIG. 1B shows a plan view of an example piezoelectric membrane in accordance with some embodiments.

FIG. 2A shows a cross-sectional view of the microfluidic device of FIG. 1A in accordance with some embodiments.

FIG. 2B shows another cross-sectional view of the microfluidic device of FIG. 1A in accordance with some embodiments.

FIG. 2C shows a cross-sectional view of an example piezoelectric actuator in accordance with some embodiments.

FIG. 3A-3C shows an example fabrication process for the microfluidic device of FIG. 1A in accordance with some embodiments.

FIG. 4 is a block diagram illustrating example electrical components for a microfluidic device in accordance with some embodiments.

FIG. 5A is a flow diagram illustrating an example method of flow control of cells or particles in a microfluidic channel in accordance with some embodiments.

FIG. 5B is a flow diagram illustrating an example method of fabricating a microfluidic device in accordance with some embodiments.

In accordance with common practice, the various features illustrated in the drawings are not necessarily drawn to scale, and like reference numerals can be used to denote like features throughout the specification and figures.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

The microfluidic devices described herein allow for electrical and/or optical sensing of one or more cells (or other particles). The microfluidic aspect of the devices allows for precise flow control (e.g., using electrodes and/or piezoelectric components). The piezoelectric component (e.g., a piezoelectric layer) having an outlet port (e.g., a nozzle) allows direct ejection (e.g., jetting) of cells (e.g., after they have been processed).

The microfluidic devices described herein can improve design flexibility, addressing a broader design space utilizing the piezoelectric material placement. For example, small (e.g., less than 20 μm) to large (e.g., greater than 200 μm) piezoelectric structures can be designed and used, which provide a wider range of performance attributes. Additionally, the piezoelectric membranes described herein can improve processing (e.g., ease of processing and reproducibility). For example, the piezoelectric membrane can be placed between an SOI handler layer and a glass top layer and encased in a passivation material (e.g., a dielectric material) such that the membrane is not exposed to mechanical stress. For example, the membrane can be formed by selectively etching the SOI. This can also allow for easier wafer handling. The devices described herein can also improve packaging flexibility and/or improve robustness (improved yield) by mechanically protecting the piezoelectric actuators and membranes.

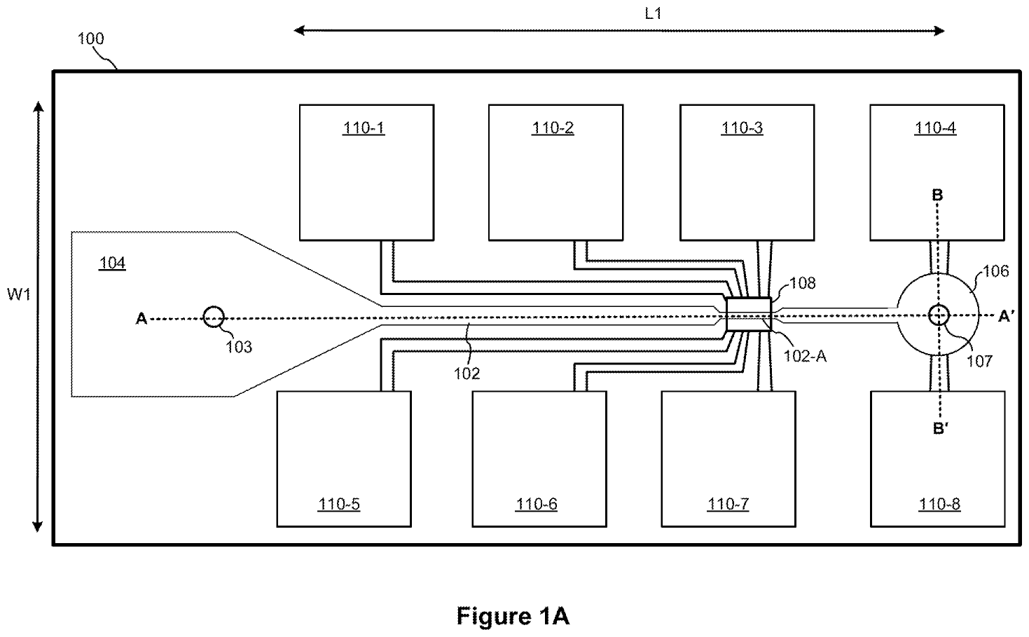

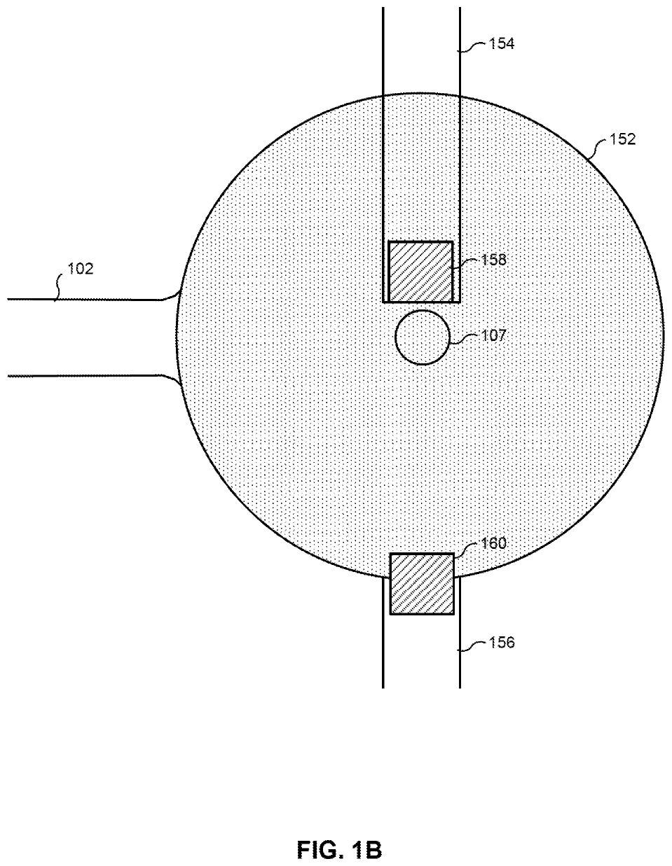

FIG. 1A shows a plan view of a microfluidic device 100 in accordance with some embodiments. The device 100 includes a fluid channel 102 (e.g., a microfluidic channel) formed on a substrate. In some embodiments, the fluid channel 102 is formed by coupling a first substrate with an indentation, recess, or notch with a second substrate so that the fluid channel 102 is defined between the first substrate and the second substrate. The device 100 in Figure TA also includes openings (apertures) 110-1 through 110-8 for electrodes, bonding pads, and/or circuitry.

The fluid channel 102 has an inlet 103 and an outlet 107. The locations of the inlet 103 and the outlet 107 shown with respect to the fluid channel 102 in Figure TA are mere examples. The inlet 103 and the outlet 107 may be defined at other locations along the length dimension of the fluid channel 102 or the device 100. In some embodiments, the length of the fluid channel 102, L1 (e.g., measured from the inlet 103 to the outlet 107), is in the range of 1 mm to 50 mm (e.g., 15 mm). In some embodiments, a width, W1, of the microfluidic device 100 is in the range of 0.2 mm to 5 mm (e.g., 0.7 mm). In some embodiments, a width of the fluid channel 102 (e.g., at a representative portion, such as sense region 102-A, which may be the narrowest portion) is configured based on a size of a particle to be analyzed. For example, for cellular measurements, the width of the fluid channel 102 may be configured in accordance with the size of the cell such that only a single cell is detected at a time. In some embodiments, the fluid channel 102 includes one or more portions that have different respective widths. For example, the fluid channel 102 may include portions having (protruding) shapes such that widths of the portions are greater than the width of the sense region 102-A. Similarly, the fluid channel 102 may include one or more portions with widths narrower than the width of the sense region 102-A. In some embodiments, the wider the fluid channel 102 is, the slower is the velocity of the particles flowing in the corresponding portion of the fluid channel 102 (e.g., when the fluid channel 102 has a uniform height). As such, for example, a wider portion is used to reduce the velocity of the particles (e.g., immobilize the particles), which allows for more time for analyzing the particles.

The device 100 also includes an input region 104 for receiving at an inlet port a sample fluid with particles (e.g., cells) as an input to the device 100 and providing the sample fluid from the inlet port to the fluid channel 102 via the inlet 103. In some embodiments, the device 100 includes a set of piezoelectric actuators at the input region 104 (e.g., around the inlet 103). The shape and size of the input region 104 in FIG. 1A is a mere example. The device 100 further includes an output region 106 for collecting at least a portion of the sample fluid from the fluid channel 102 and ejecting or delivering the sample fluid portion via the outlet 107 (e.g., a nozzle) for further processing or analysis. The shape and size of the output region 106 in FIG. 1A is a mere example. In some embodiments, the output region 106 includes a set of piezoelectric actuators located adjacent to the outlet 107 for ejecting a portion of the fluid in the fluid channel 102. In some embodiments, the set of piezoelectric actuators includes one or more piezoelectric actuators (e.g., a piezo micro-electro-mechanical system (MEMS) actuator). In some embodiments, the set of piezoelectric actuators includes two or more piezoelectric actuators. In some embodiments, the device 100 includes actuation circuitry electrically coupled to the set of piezoelectric actuators. In some embodiments, upon application of an electrical signal from the actuation circuitry, the set of piezoelectric actuators generates oscillations that create displacement as well as acoustic waves, which controls localized inertial movement of the particles in the fluid channel 102 in the three-dimensional x, y, and z planes with sub-micron level control. In some embodiments, the set of piezoelectric actuators induces a laminar flow from the input region 104 toward the outlet 107.

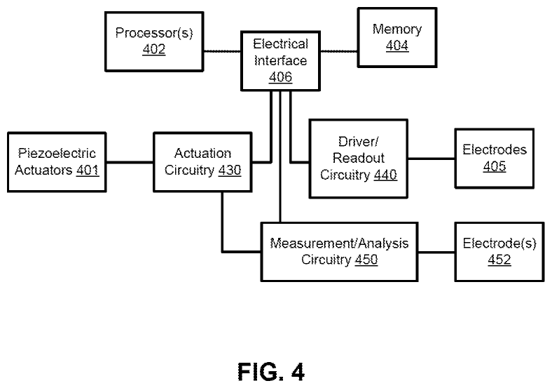

The device 100 includes a set of electrodes 108 (e.g., a pair of electrodes). The set of electrodes 108 may be used for charging particles flowing through the fluid channel 102 so that the particles can be manipulated with an electrical field. In some embodiments, the distance between a pair of the electrodes is configured such that only a single cell is manipulated with an electrical field at a time. In some embodiments, the device 100 includes driver circuitry (e.g., driver circuitry 440 described with respect to FIG. 4) electrically coupled to one or more of the electrodes. In some embodiments, the driver circuitry is configured to produce electrical signals in the megahertz and gigahertz frequency domains. In some embodiments, the frequency of the electrical signals provided to the electrodes depends on a type or types of the particles to be analyzed using the device 100.

In some embodiments, the device 100 includes a second array of piezoelectric actuators, one or more (pairs of) electrodes, and/or a third array of piezoelectric actuators. In some embodiments, the second array of piezoelectric actuators is located adjacent to the inlet 103 for inducing a laminar flow from the inlet 103 toward the outlet 107. In some embodiments, the second array of piezoelectric actuators is configured for sample input mixing and/or disassociation. In some embodiments, the second array of piezoelectric actuators is located between the inlet 103 and the outlet 107. For example, the second array of piezoelectric actuators may be located laterally between the inlet 103 and the outlet 107 (e.g., the inlet 103 may be located in an upstream region of the microfluidic channel, the outlet 107 may be located in a downstream region of the microfluidic channel, and the second array of piezoelectric actuators may be located in a midstream region of the microfluidic channel). In some embodiments, a third array of piezoelectric actuators is located between the inlet 103 and the outlet 107. Similar to the first array of piezoelectric actuators, in some embodiments, each of the second and third arrays of piezoelectric actuators includes one or more piezoelectric actuators (e.g., a piezo micro-electro-mechanical system (MEMS) actuator).

In some embodiments, the device 100 includes two or more output regions and the electrodes 108 operate to direct different types of particles to different output regions. In some embodiments, each output region has an outlet port and a set of piezoelectric actuators. In some embodiments, different portions (e.g., each portion corresponding to a particular cell or a type of cell) of the sample fluid from the inlet 103 is deflected toward a corresponding output region. As such, each of the different portions of the sample fluid is collected at, and ejected from, the corresponding output region. The deflection of the different portions of the sample fluid may be achieved, for example, by the oscillations and displacement caused by the activation of piezoelectric actuators.

In some embodiments, upon application of an electrical signal from the actuation circuitry, the second array of piezoelectric actuators generates oscillations that create displacement as well as acoustic waves which causes mixing and dissociation of the sample fluid and controls localized inertial movement of the particles to induce a laminar flow in the fluid channel 102. In some configurations, the sample fluid flows through the fluid channel 102 at a rate between 1 μL/min and 1 mL/min. In some embodiments, when activated using an appropriate electrical signal from the actuation circuitry, the third array of piezoelectric actuators is configured for deflecting charged particles (which have been manipulated using an electrical field generated by one or more pairs of electrodes) toward a specific output region. In some embodiments, one or more pairs of electrodes charge particles flowing through the fluid channel 102 so that the particles can be manipulated with an electrical field.

In some embodiments, one or more pairs of electrodes detect electrical signals of particles (e.g., cells) flowing through the microfluidic channel 102 adjacent to the one or more pairs of electrodes. In some embodiments, the driver circuitry is electrically coupled to the electrodes and is configured to produce electrical signals in the megahertz and gigahertz frequency domains. In some embodiments, the driver circuitry is configured to produce electrical signals with a voltage in the range of 1 volt to 100 volts. In some embodiments, the driver circuitry is configured to produce electrical signals with a pulse in a range from 1 μs to 20 μs. In some embodiments, the pulse is a sawtooth pulse, a square pulse, or a sinusoidal pulse. In some embodiments, the device 100 includes readout circuitry (e.g., driver/readout circuitry 440 described with respect to FIG. 4) electrically coupled with one or more electrodes. In some embodiments, the readout circuitry receives electrical signals from one or more electrodes and relays the electrical signals (with or without processing, such as filtering) to one or more processors of, or operationally connected with, the device 100.

In some embodiments, one or more pairs of electrodes provide electrical fields for inducing movement (e.g., deflection) of charged particles (e.g., particles charged by other pairs of electrodes). For example, the electrical fields provided by one or more pairs of electrodes may induce direct movement of the charged particles by providing a potential difference. As another example, the electrical fields provided by one or more pairs of electrodes may be used to control position, rotation and/or acceleration of the charged particles. Additionally or alternatively, the electrical fields provided by one or more pairs of electrodes may induce electrohydrodynamic flow of the fluid (e.g., when the fluid includes dielectric media).

In some embodiments, each particle may pass the vicinity of one or more pairs of electrodes for a period between 0.1 and 100 milliseconds. In some embodiments, each particle may pass the vicinity of one or more second pairs of electrodes for a period between 0.1 and 100 milliseconds.

In some embodiments, a separation distance between a pair of electrodes as well as a distance between the first electrodes and the second electrodes are configured based on a type or types of the particles to be analyzed using the device 100. In some embodiments, a particle processing rate in the microfluidic device 100 is between from 100 particles per minute and 1 million particles per minute.

In some embodiments, the electrodes are located on a same substrate as one another and/or the piezoelectric components. In some embodiments, a pair of electrodes is located on different substrates (e.g., one electrode of a pair of electrodes is located on a bottom substrate and the other electrode of the pair of electrodes is located on a top substrate).

The position of the sense region 102-A in Figure TA is a mere example. The position of the set of electrodes 108 and the sense region 102-A may be varied along the length of the channel. For example, it may be beneficial to have the “sense” zone electrodes length balanced (e.g., the length and width of electrodes from sense region 102-A to the pad 110-1 and to the other pad 110-3 may be the same) to acquire accurate impedance measurements.

FIG. 1B shows a plan view of a piezoelectric membrane 152 in accordance with some embodiments. The piezoelectric membrane 152 be positioned in the output region 106 shown in Figure TA (e.g., above an output channel). As discussed in more detail below, the piezoelectric membrane 152 may include a substrate 209 (e.g., a buried oxide layer and/or a device layer), a passivation layer, and a piezoelectric material (e.g., PZT). In some embodiments, the piezoelectric material is polyvinylidene fluoride, gallium phosphate, sodium bismuth titanate, lead zirconate titanate, quartz, berlinite (AlPO4), sucrose (table sugar), rochelle salt, topaz, tourmaline-group minerals, lead titanate (PbTiO3), langasite (La3Ga5SiO14), gallium orthophosphate (GaPO4), lithium niobate (LiNbO3), lithium tantalate (LiTaO3), any of a family of ceramics with perovskite, tungsten-bronze, potassium niobate (KNbO3), sodium tungstate (Na2WO3), Ba2NaNb5O5, Pb2KNb5O15, sodium potassium niobate ((K,Na)NbO3) (e.g., NKN, or KNN), bismuth ferrite (BiFeO3), sodium niobate (NaNbO3), barium titanate (BaTiO3), bismuth titanate (Bi4Ti3O12), sodium bismuth titanate (NaBi(TiO3)2), zincblende crystal, GaN, InN, AlN, and ZnO.

The piezoelectric membrane 152 includes the outlet 107 (e.g., a nozzle) for the channel 102. FIG. 1B also shows an electrical path 154 and corresponding contact 158 (e.g., coupled to a first electrode) and an electrical path 156 and corresponding contact 160 (e.g., coupled to a second electrode). The first and second electrodes may be coupled to one or more piezoelectric layers to actuate the piezoelectric material and eject fluid via the outlet 107. In some embodiments, the outlet 107 has a diameter of less than 200 μm (e.g., 30, 60, or 120 m). In some embodiments, the piezoelectric member 152 has a diameter in the range of 200 μm to 1500 μm (e.g., 300, 600, or 1200 μm).

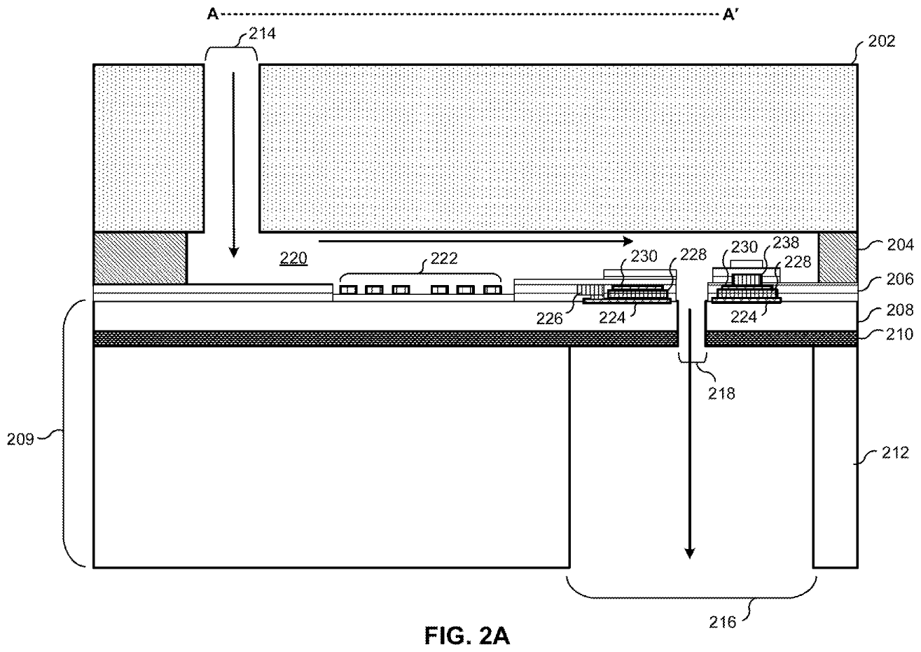

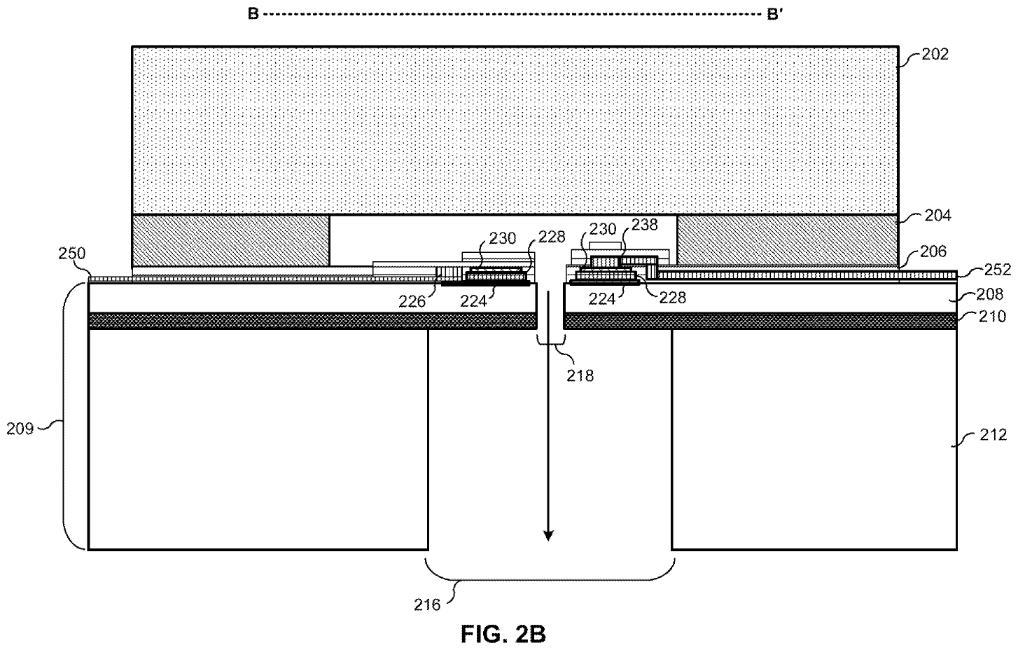

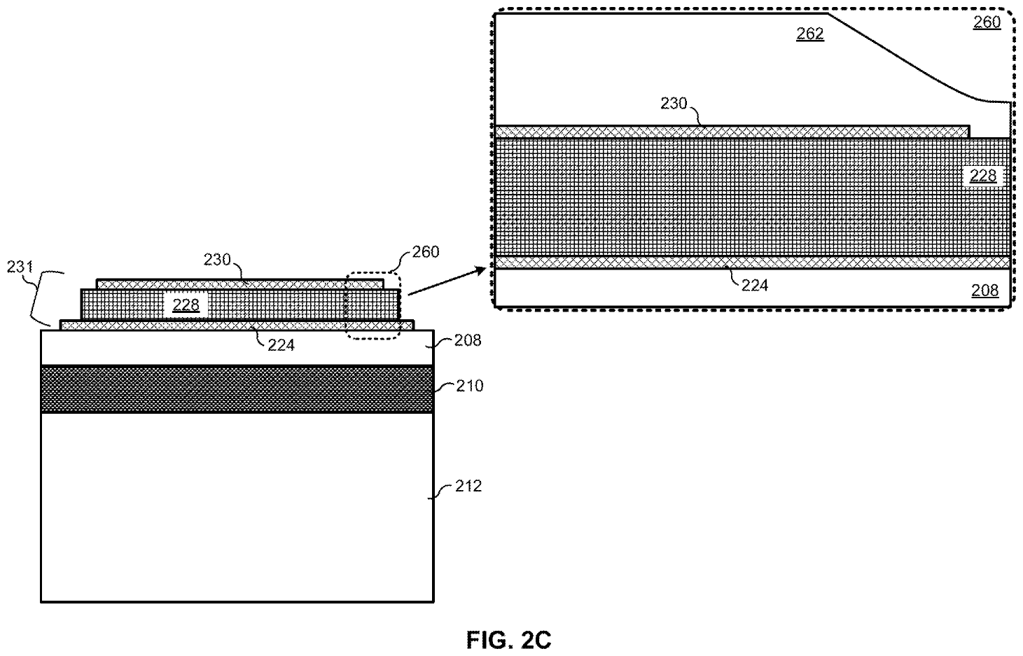

FIG. 2A shows a cross-sectional view of the microfluidic device 100 in the A-A′ direction in accordance with some embodiments. As shown in FIG. 2A, the device 100 includes an optical layer 202 (e.g., composed of glass) with an inlet channel 214. The optical layer 202 is coupled to a substrate 209 via a bonding layer 204. The bonding layer 204 defines a microfluidic channel 220 (e.g., the microfluidic channel 102). In the example of FIG. 2A, the substrate 209 includes a handler layer 212, a buried oxide (BOX) layer 210 (e.g., composed of SiO2), and a device layer 208. In some embodiments, the device layer 208 has a thickness in the range of 1 μm to 5 μm. In some embodiments, the handler layer 212 has a thickness in the range of 200 μm to 600 μm.

In accordance with some embodiments, an outlet channel 216 is defined in the substrate 209 (e.g., etched in the handler layer 212). In accordance with some embodiments, an outlet 218 (e.g., the outlet 107) is defined in the substrate 209 (e.g., through the BOX layer 210 and the device layer 208. A passivation layer 206 (e.g., an encapsulation layer) is coupled to the substrate 209. The device 100 includes bottom electrode 224, top electrode 230, and piezoelectric layer 228 (e.g., encircling the outlet 218). The device further includes a contact 226 coupled to the bottom electrode 224 and a contact 238 coupled to the top electrode 230. The passivation layer 206 separates the electrodes 224 and 230 and the piezoelectric layer 228 from the channel 220. In accordance with some embodiments, electrodes 222 are arranged in the channel 220. The number and location of the electrodes 222 in FIG. 2A are merely an example. In some embodiments, the electrodes 222 have a thickness in the range of 0.01 μm to 2 μm. Other embodiments may include a different number of electrodes and/or a different placement of the electrodes.

In some embodiments, the channel 220 is defined by the optical layer 202, the bonding layer 204, and the device layer 208. In some embodiments, the channel 220 has a height between 10 microns and 1 mm (e.g., 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, or 1 mm, or within a range between any two of the aforementioned values). In some embodiments, the optical layer 202 has a thickness between 5 microns and 2 mm (e.g., 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 mm, 1.1 mm, 1.2 mm, 1.3 mm, 1.4 mm, 1.5 mm, 1.6 mm, 1.7 mm, 1.8 mm, 1.9 mm, or 2 mm, or within a range between any two of the aforementioned values). In some embodiments, the substrate 209 is 500 microns thick. In some embodiments, the inlet 103 is defined in the substrate 209 (e.g., in addition to, or alternatively to, being defined in the optical layer 202).

In some embodiments, a bonding layer 204 is positioned between optical layer 202 and the substrate 209 (e.g., between the optical layer 202 and the device layer 208). In some embodiments, the bonding layer 204 is composed of a polymer. Examples of polymers and organic material include: polyvinylidene fluoride (PVDF) and its copolymers, polyamides, and paralyne-C, polyimide and polyvinylidene chloride (PVDC), and diphenylalanine peptide nanotubes (PNTs).

In some embodiments, the bonding layer 204 is adapted and/or positioned to adhere the optical layer 202 (e.g., a first substrate) and the substrate 209 (e.g., a second substrate) to one another. For example, if the bonding layer 204 is not included then the optical layer 202 may not bond to the substrate 209. In some embodiments, the bonding layer 204 is composed of a photo-imageable material. For example, imaging the bonding layer 204 provides definition of the fluidic channel 220, such as its width, height, and curvature (e.g., which can improve the signal-to-noise ratio (SNR) for single cell sensing). In some embodiments, the bonding layer 204 is adapted and/or positioned to provide stress relief for the device 100 (e.g., to prevent stress cracking when the chip is assembled in a package). In some embodiments, the bonding layer 204 is cured/hardened (e.g., submitted to multiple stages of curing/hardening). In some embodiments, the bonding layer 204 is submitted to a temperature that exceeds a transition temperature (e.g., 150 degrees Celsius) for the bonding layer, whereby the bonding layer cures and bonds the optical layer 202 (e.g., glass) to the substrate 209 (e.g., silicon). In some embodiments, the bonding layer 204 is composed of a liquid or a dry film. The bonding layer 204 may be a negative or positive photo-resist. In some embodiments, the bonding layer 204 is composed of an epoxy (e.g., bisphenol-A) and/or polyimides with photo initiators (e.g., added to drive cross linking based on the wavelength of light).

In some embodiments, the piezoelectric layer 228 has a thickness between 0.1 microns and 100 microns (e.g., 0.1 microns, 0.5 microns, 1 microns, 2 microns, 5 microns, 10 microns, 20 microns, 30 microns, 40 microns, 50 microns, 60 microns, 70 microns, 80 microns, 90 microns, or 100 microns, or within a range between any two of the aforementioned values). In some embodiments, the piezoelectric layer 228 is positioned on a silicon-on-insulator (SOI) layer. In some embodiments, the silicon-on-insulator (SOI) layer is connected to one or more of the contacts (e.g., the contact 226).

FIG. 2B shows a cross-sectional view of the microfluidic device 100 in the B-B′ direction in accordance with some embodiments. As shown in FIG. 2B, a conductive layer 252 is coupled to the contact 238 (e.g., corresponding to the electrical path 154 and the contact 158 in FIG. 1B) and a conductive layer 250 is coupled to the contact 226 (e.g., corresponding to the electrical path 156 and the contact 160 in FIG. 1B). In some embodiments, the conductive layers 250 and 252 are each composed of an electrically-conductive material (e.g., copper, aluminum, gold, or platinum). In some embodiments, a respective bond pad is coupled to each of the conductive layers 250 and 252. In some embodiments, the electrodes 224 and 230 are each composed of an electrically-conductive material (e.g., copper, aluminum, gold, or platinum).

FIG. 2C shows a cross-sectional view of a piezoelectric actuator 231 in accordance with some embodiments. The piezoelectric actuator 231 includes the bottom electrode 224, the piezoelectric layer 228, and the top electrode 230. In some embodiments, the piezoelectric layer 228 is composed of PZT and has a thickness in the range of 0.1 μm-10 μm (e.g., 2 μm). In some embodiments, the bottom electrode 224 and/or the top electrode 230 is composed of Strontium oxide (SRO) and/or Titanium. In some embodiments, the bottom electrode 224 and/or the top electrode 230 has a thickness in the range of 100 A to 500 A. FIG. 2C includes a cross section 260 that shows a portion of the device layer 208, the top electrode 230, the bottom electrode 224, and the piezoelectric layer 228. The cross section 260 also includes a layer 262 (e.g., a resist layer).

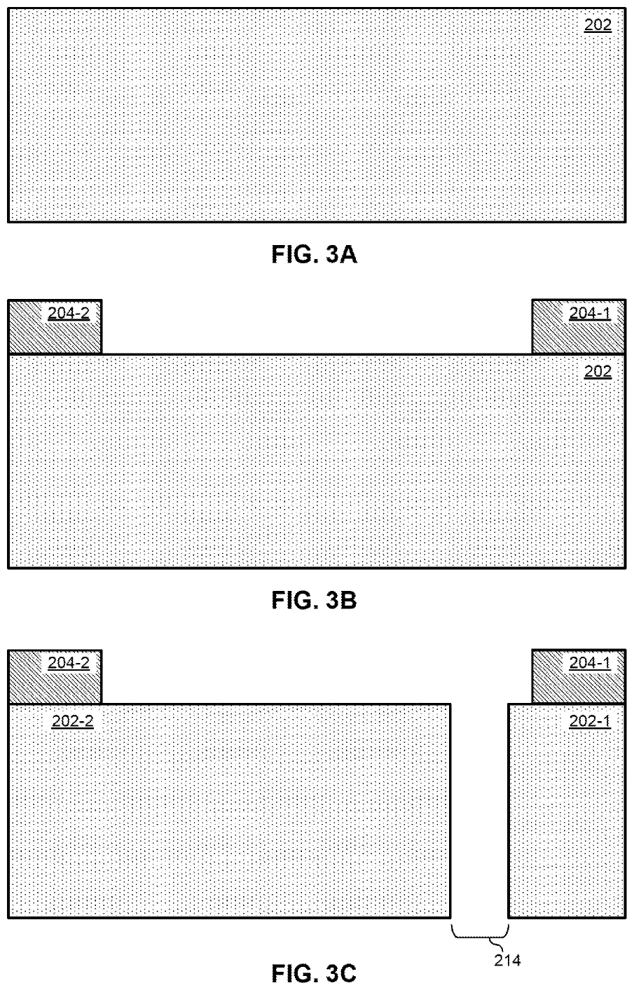

FIG. 3A-3C shows an example fabrication process for the microfluidic device of FIG. 1A in accordance with some embodiments. FIG. 3A shows the optical layer 202 (e.g., a glass substrate). FIG. 3B shows the bonding layer 204 applied to the optical layer 202 (as portions 204-1 and 204-2). In some embodiments, the bonding layer 204 is a polymer fluidic layer. In some embodiments, the bonding layer 204 is applied via a polymer spin coat and patterning (e.g., to form the fluidic channel and access to bond pads). In some embodiments, the spin coat has a thickness in the range of 10 μm to 100 μm (e.g., 50 μm). FIG. 3C shows an access channel (e.g., the inlet channel 214) created in the optical layer 202 (e.g., via a laser drill and/or etching process). In some embodiments, a laser drill process is used to form inlets and/or outlets. In some embodiments, a laser drill process is used to etch bond pad(s).

FIG. 4 is a block diagram illustrating example electrical components for a microfluidic device in accordance with some embodiments. In some embodiments, a device (e.g., the device 100) includes one or more processors 402 and memory 404. In some embodiments, the memory 404 includes instructions for execution by the one or more processors 402. In some embodiments, the stored instructions include instructions for providing actuation signals to one or more piezoelectric actuators (e.g., the piezoelectric actuator 231). In some embodiments, the actuation signals for the different piezoelectric actuators are configured such that each of the piezoelectric actuators create oscillations at a different frequency. For example, one or more of the piezoelectric actuators may operate at a frequency in the range between 1 kHz and 100 kHz, for example, based on desired flow rates. In some embodiments, the stored instructions include instructions for providing actuation signals to one or more of the electrodes 222 for charging particles flowing through the fluid channel 220 so that the particles can be manipulated with an electrical field. In some embodiments, the device also includes an electrical interface 406 coupled with the one or more processors 402 and the memory 404. In some embodiments, the device further includes actuation circuitry 430, which is coupled to one or more piezoelectric actuators 401, such as the piezoelectric actuator 231. For example, the actuation circuitry 430 sends electrical signals to the piezoelectric actuators to initiate actuation of the piezoelectric actuators.

In some embodiments, the device further includes driver circuitry 440, which is coupled to one or more electrodes 405, such as the electrodes 222, 224, and/or 230. For example, the driver circuitry 440 sends electrical signals to the one or more electrodes to generate an electrical field using the one or more electrodes for charging particles flowing through the fluid channel. In some embodiments, the device further includes readout circuitry (e.g., the driver/readout circuitry 440), which is coupled to one or more electrodes 405. The readout circuitry receives electrical signals from the one or more electrodes 405 and provides the electrical signals (with or without processing) to the one or more processors 402 via the electrical interface 406.

In some embodiments, the device further includes measurement/analysis circuitry 450 coupled to one or more electrodes 452. In some embodiments, the measurement/analysis circuitry 450 is configured to detect particle impedance of particles in the microfluidic channel (e.g., the channel 220). In some embodiments, the measurement/analysis circuitry 450 is coupled to the actuation circuitry 430 and informs the actuation circuitry 430 how to actuate the piezoelectric actuators (e.g., based on the impedance measurements). In some embodiments, the actuation circuitry 430 is configured to adjust actuation of one or more piezoelectric actuators (e.g., adjust frequency and/or magnitude) based on particle analysis results from the measurement/analysis circuitry 450. In some embodiments, one or more electrodes are shared between the electrode(s) 405 and the electrode(s) 452.

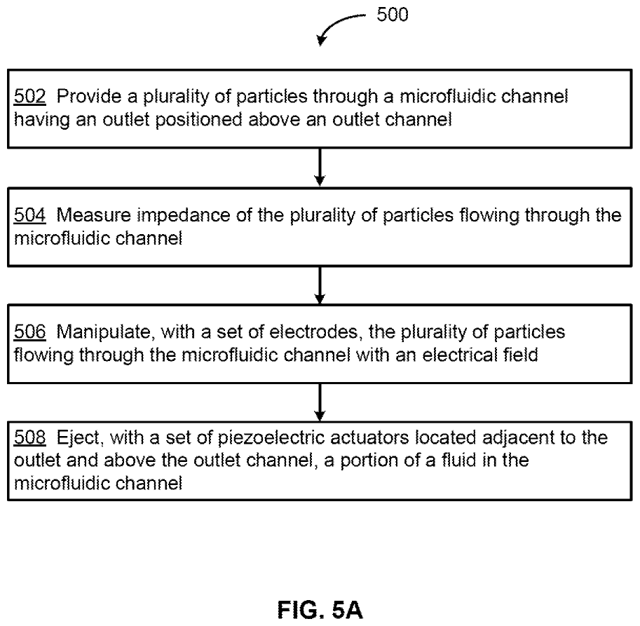

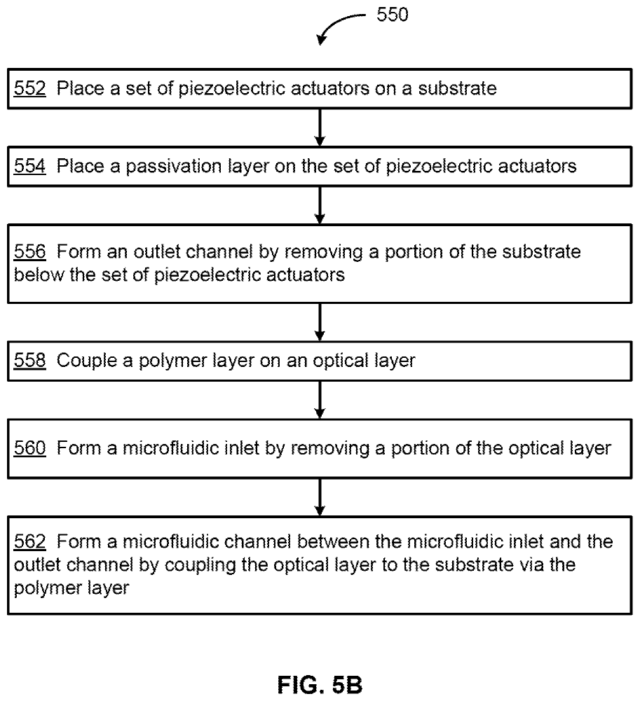

FIG. 5A is a flow diagram illustrating a method 500 of flow control of cells or particles in a microfluidic channel in accordance with some embodiments. In some embodiments, the method 500 is performed at a microfluidic device (e.g., the device 100).

The method 500 includes (502) providing a plurality of particles through a microfluidic channel (e.g., the channel 220) having an outlet (e.g., the outlet 218) positioned above an outlet channel (e.g., the outlet channel 216). For example, a sample fluid with particles (e.g., cells) is provided in the fluid channel 102 with the inlet 103 and the outlet 107.

In some embodiments, the method 500 includes inducing, with a first set of piezoelectric actuators, a laminar flow from an inlet of the microfluidic channel toward the outlet. For example, the first set of piezoelectric actuators may induce a laminar flow from the inlet 103 toward the outlet 107 of the fluid channel 102. As an example, the first set of piezoelectric actuators are located adjacent to the inlet 103 to induce a laminar flow from the inlet 103 toward the outlet 107 of the fluid channel 102. The first set of piezoelectric actuators may be activated or actuated based on actuation signals from the one or more processors 402.

The method 500 includes (504) measuring impedance (e.g., via the measurement/analysis circuitry 450) of the plurality of particles flowing through the microfluidic channel. In various embodiments, the impedance is measured before and/or after manipulating the particles. In some embodiments, the impedance is measured with a second set of electrodes (e.g., the electrode(s) 452). In some embodiments, the method 500 includes measuring one or more properties of the particles flowing through the microfluidic channel.

The method 500 includes (506) manipulating, with a set of electrodes (e.g., the electrodes 222 and/or 405), the particles flowing through the microfluidic channel with an electrical field. For example, charging the particles flowing through the microfluidic channel so that the particles can be manipulated with an electrical field. As an example, once activated, a set of electrodes (e.g., at least a subset of the electrodes 222) charge the particles flowing through the fluid channel so that the particles can be manipulated with an electrical field.

In some embodiments, the method 500 includes providing actuation signals to one or more pairs of electrodes for charging the particles flowing through the microfluidic channel. For example, the one or more processors 402 provide actuation signals to the electrodes 222 so that the particles in the fluid channel 220 can be manipulated with an electrical field.

In some embodiments, the method 500 includes (508) ejecting, with a set of piezoelectric actuators (e.g., the piezoelectric actuator 231) located adjacent to the outlet and above the outlet channel, a portion of a fluid in the microfluidic channel. For example, once activated or actuated, the piezoelectric actuator 231 causes displacement and oscillations for ejecting a portion of a fluid in the fluid channel 220 via the outlet 218. In some embodiments, the method 500 includes providing actuation signals to the set of piezoelectric actuators, e.g., from the one or more processors 402. In some embodiments, the set of piezoelectric actuators and the outlet are sized to be able to eject particles with a diameter ranging from 100 nm-100 μm. In some embodiments, the method further includes inducing, with a second set of piezoelectric actuators, a laminar flow from an inlet of the microfluidic channel toward the outlet. In some embodiments, the actuation signals for the set of piezoelectric actuators are generated to create an oscillation frequency in the actuators that is based on a fluid composition (e.g., size and/or concentration of particles) in the microfluidic channel. For example, the actuators are configured to oscillate such that only 1 cell is ejected at a time.

FIG. 5B is a flow diagram illustrating a method 550 of fabricating a microfluidic device in accordance with some embodiments.

The method 550 includes (552) placing a set of piezoelectric actuators (e.g., the piezoelectric actuator 231) on a substrate (e.g., the substrate 209). In some embodiments, the substrate includes a device layer (e.g., with a thickness of 1-5 μm), a BOX layer (e.g., with a thickness in the range of 0.5-5 μm), and a handler layer (e.g., with a thickness in the range of 400 μm-500 μm).

The method 550 also includes (554) placing a passivation layer (e.g., the passivation layer 206) on the set of piezoelectric actuators. In some embodiments, the passivation layer has a thickness in the range of 0.01p m to 1p m. In some embodiments, the passivation layer is an encapsulation layer. In some embodiments, placing the passivation layer includes depositing Silicon Nitride. In some embodiments, the passivation layer is composed of Silicon Nitride, Silicon Carbide, SiO2 made from TEOS or Silazane, Aluminum Nitride, Aluminum Oxide, and/or photo-imageable polymers. In some embodiments, a thickness of the passivation layer is based on a thickness of the set of piezoelectric actuators and/or desired piezoelectric oscillation attributes.

In some embodiments, the method 550 includes patterning and etching the passivation layer to place/form electrode contacts.

The method 550 also includes (556) forming an outlet channel (e.g., the outlet channel 216) by removing a portion of the substrate below the set of piezoelectric actuators. In some embodiments, the method 550 includes patterning and etching the device layer and the BOX layer to form an outlet (e.g., a nozzle). In some embodiments, the handler layer for the SOI is the etched all the way through to define a “tunnel” through which a droplet is ejected (e.g., bypassing/avoiding any “thin wafer handling” processes, including dicing).

In some embodiments, the method 550 includes outlet (nozzle) formation. For example, nozzle formation is performed via a multi-step etching process. For example, first step forms a backside which stops on the SOI layer (e.g., a selective DRIE etch that also defines an outlet membrane). In this example, the second etch is from a topside to break through the SOI layer. In some embodiments, the SOI wafer is not thinned. Instead, a hole is made in the region of the membrane to enable droplet ejection, thereby improving wafer handling, improving yield, and/or enabling a wider design space for larger piezoelectric actuators and/or membranes.

The method 550 also includes (558) coupling a polymer layer (e.g., the bonding layer 204) to an optical layer (e.g., the optical layer 202). For example, FIG. 3B shows the bonding layer 204 positioned on the optical layer 202. In some embodiments, the optical layer is a glass substrate (e.g., with a thickness in the range of 200 μm to 700 μm (e.g., 500 μm)). In some embodiments, the polymer layer is spin coated, exposed, and developed to form the microfluidic channel. In some embodiments, the bond pads are exposed so that the electrodes can be accessed. In some embodiments, the optical layer allows for hybrid optical-electrical sensing.

The method 550 also includes (560) forming a microfluidic inlet (e.g., the inlet channel 214) by removing a portion of the optical layer. For example, FIG. 3C shows the inlet channel 214 formed in the optical layer 202. In some embodiments, the optical layer is laser drilled to form the inlet (and/or other holes for electrical contacts).

The method 550 also includes (562) forming a microfluidic channel (e.g., the channel 220) between the microfluidic inlet and the outlet channel by coupling the optical layer to the substrate via the polymer layer. In some embodiments, the optical layer and polymer layer are aligned and bonded to a silicon device wafer.

Some embodiments include positioning a piezoelectric (e.g., PZT) actuator and a nozzle inside a SOI-polymer-glass hybrid structure. Some embodiments include configuration of a piezoelectric actuator that applies to microfluidic channel. Some embodiments include an electrode array for sensing the cells or particles placed on the same layer as the actuator electrodes, which can improve fabrication, processing, and interconnection of the device. Thus, a high throughput, high fidelity, single cell processing system with integrated inertial flow, sorting, and delivery for post processing of cells is disclosed. The PZT structure can drive actuation as well as delivery of droplets containing particles, cells, and/or therapeutics through a nozzle built in the PZT stack itself. The ejection of droplets can occur through the “large via” made in the handler layer of the SOI wafer.

In light of the above disclosure certain embodiments are described below.

(A1) In one aspect, some embodiments include a microfluidic device (e.g., the microfluidic device 100), including: (i) a substrate (e.g., the substrate 209) having an outlet channel (e.g., the outlet channel 216); (ii) a microfluidic channel (e.g., the microfluidic channel 220) arranged on the substrate such that an outlet (e.g., the outlet 218) of the microfluidic channel is positioned above the outlet channel; and (iii) a set of piezoelectric actuators (e.g., the piezoelectric layer 228) arranged above the outlet channel and adjacent to the outlet, the set of piezoelectric actuators configured to eject a portion of a fluid out of the microfluidic channel via the outlet. In some embodiments, the set of piezoelectric actuators consists of one piezoelectric actuator. As an example, the substrate may be a silicon-on-insulator (SOI) substrate. The set of piezoelectric actuators may be composed of lead zirconate titanate (PZT). In some embodiments, the piezoelectric actuators have a thickness in the range of 0.1 μm-5 μm. In some embodiments, the outlet has a diameter in the range of 20 μm-150 μm. As an example, the microfluidic channel extends on the substrate and the outlet channel is formed through a thickness of the substrate. In some embodiments, the outlet includes a hole that is formed through a thickness of the set of piezoelectric actuators and entirely enclosed within edges of the set of piezoelectric actuators. In some embodiments, the fluid is configured to be ejected out of the microfluidic channel via the hole of the outlet. In some embodiments, the set of piezoelectric actuators are attached to a polymer layer. In some embodiments, the set of piezoelectric actuators are protected with an insulator such that they are not in contact with the conductive fluid. In some embodiments, the set of piezoelectric actuators have a diameter in the range of 100 μm to 300 μm.

(A2) In some embodiments of A1, the outlet includes a hole that is formed through a thickness of the set of piezoelectric actuators and enclosed by the set of piezoelectric actuators.

(A3) In some embodiments of A1 or A2, the set of piezoelectric actuators are arranged on a membrane on the outlet channel. In various embodiments, the membrane is positioned above, below, or otherwise adjacent to the outlet channel. For example, the membrane may be composed of a thin layer of substrate (e.g., thickness in the range of 1 μm to 5 μm). In some embodiments, the membrane separates the outlet channel and a corresponding portion of the microfluidic channel. As an example, the membrane may include the portion of the BOX layer 210 and the device layer 208 positioned above the outlet channel 216 (as illustrated in FIG. 2A).

(A4) In some embodiments of any of A1-A3, the microfluidic device further includes a passivation layer (e.g., an encapsulation layer) arranged between the set of piezoelectric actuators and the microfluidic channel. For example, the passivation layer (e.g., the passivation layer 206) may be composed of nitride. In some embodiments, the passivation layer has a thickness in the range of 0.01 μm-1 μm. Example passivation materials include silicon nitride, silicon carbide, SiO2, aluminum nitride, aluminum oxide, and photo-imageable polymers.

(A5) In some embodiments of any of A1-A4, the microfluidic device further includes a first electrode (e.g., the top electrode 230) and a second electrode (e.g., the bottom electrode 224), where the first electrode and the second electrode are configured to provide actuation signals to the set of piezoelectric actuators, and where the set of piezoelectric actuators are positioned between the first electrode and the second electrode. For example, the first and second electrodes may be composed of gold (Au). In some embodiments, each of the first and second electrodes has a thickness in the range of 0.05 μm-2 μm.

(A6) In some embodiments of any of A1-A5, the microfluidic device further includes an optical layer (e.g., the optical layer 202), where the microfluidic channel is arranged between the optical layer and the substrate. For example, the optical layer may be composed of glass. In some embodiments, the optical layer comprises a passivation layer. In some embodiments, a non-optical top layer is used in place of the optical layer 202. In some embodiments, the optical layer comprises a top layer. In some embodiments, the optical layer is composed of a transparent and/or translucent material.

(A7) In some embodiments of any of A1-A6, the microfluidic device further includes a polymer layer (e.g., the bonding layer 204) that defines at least a portion of the microfluidic channel. In some embodiments, the polymer layer bonds the substrate to the optical layer. In some embodiments, a non-polymer bonding layer is used in place of the polymer layer.

(A8) In some embodiments of any of A1-A7, the microfluidic device further includes one or more electrodes (e.g., the electrodes 222) arranged adjacent to the microfluidic channel and configured to apply an electrical field to the fluid. In some embodiments, the one or more electrodes have a thickness in the range of 0.01 μm-1 μm. In some embodiments, the set of piezoelectric actuators and the one or more electrodes are arranged on a same layer (e.g., arranged on the passivation layer 206).

(A9) In some embodiments of any of A1-A8, the substrate includes a silicon base layer (e.g., the handler layer 212) and a buried oxide (BOX) layer (e.g., the BOX layer 210), where the BOX layer separates the microfluidic channel from the silicon base layer. For example, the BOX layer separates the silicon base layer from a device layer. As an example, the silicon base layer may have a thickness in the range of 200 μm-600 μm and the device layer may have a thickness in the range of 1 μm to 5 μm.

(A10) In some embodiments of any of A1-A9, the microfluidic device further includes a second set of piezoelectric actuators arranged adjacent to an inlet of the microfluidic channel. In some embodiments, a third set of piezoelectric actuators located between the inlet and the outlet.

(A1 l) In some embodiments of any of A1-A10, the microfluidic device further includes control circuitry (e.g., the processor(s) 402, the actuation circuitry 430, the electrical interface 406, and/or the driver/readout circuitry 440) electrically coupled to the set of piezoelectric actuators and configured to provide actuation signals to the set of piezoelectric actuators. In some embodiments, the control circuitry is further configured to provide activation signals to one or more electrodes to selectively charge particles flowing through the microfluidic channel.

(B1) In another aspect, some embodiments include a method (e.g., the method 500) that includes: (i) providing a plurality of particles through a microfluidic channel having an outlet positioned above an outlet channel; (ii) measuring (e.g., via the measurement/analysis circuitry 450) an impedance of the particles flowing through the microfluidic channel; (iii) manipulating (e.g., via the driver/readout circuitry 440), with a set of electrodes, the particles flowing through the microfluidic channel with an electrical field; and (iv) ejecting, with a set of piezoelectric actuators located adjacent to the outlet and above the outlet channel, a portion of a fluid in the microfluidic channel. In some embodiments, the set of piezoelectric actuators and the outlet are sized to be able to eject particles with a diameter ranging from 100 nm-100 μm. In some embodiments, the method further includes inducing, with a second set of piezoelectric actuators, a laminar flow from an inlet of the microfluidic channel toward the outlet. In various embodiments, the impedance of the particles flowing through the microfluidic channel is measured prior to, during, or after manipulating the particles. In some embodiments, the particles flowing through the microfluidic channel are manipulated based on the measured impedances.

(B2) In some embodiments of B1, the method further includes providing actuation signals (e.g., via the actuation circuitry 430) to the set of piezoelectric actuators; and providing electrical signals (e.g., via the driver/readout circuitry 440) to the set of electrodes. In some embodiments, the actuation signals for the set of piezoelectric actuators are generated to create an oscillation frequency in the actuators that is based on a fluid composition (e.g., size and/or concentration of particles) in the microfluidic channel. For example, the actuators are configured to oscillate such that only 1 cell is ejected at a time.

(B3) In some embodiments of B1 or B2, the method further includes providing (e.g., via the electrical interface 406) actuation signals (e.g., from the actuation circuitry 430) to the first array of piezoelectric actuators.

(C1) In another aspect, some embodiments include a method that includes: (i) placing a set of piezoelectric actuators (e.g., the piezoelectric actuator 231) on a substrate (e.g., the substrate 209); (ii) placing a passivation layer (e.g., the passivation layer 206) on the set of piezoelectric actuators; (iii) forming an outlet channel (e.g., the outlet channel 216) by removing a portion of the substrate below the set of piezoelectric actuators; (iv) coupling a polymer layer (e.g., the bonding layer 204) to an optical layer (e.g., the optical layer 202); (v) forming a microfluidic inlet (e.g., the inlet channel 214) by removing a portion of the optical layer; and (vi) forming a microfluidic channel (e.g., the channel 220) between the microfluidic inlet and the outlet channel by coupling the optical layer to the substrate via the polymer layer. In some embodiments, the polymer layer has a thickness in the range of 20 μm-100 μm. In some embodiments, the microfluidic channel includes a sensor region (e.g., the region 102-A) between the inlet and the outlet. In some embodiments, the microfluidic channel is shaped to narrow at the sensor region. In some embodiments, coupling the optical layer to the substrate via the polymer layer comprises bonding the polymer layer to the passivation layer. In some embodiments, coupling the optical layer to the substrate comprises applying pressure and heat to the polymer layer to form a laminate composite structure. In some embodiments, the polymer layer is coupled to the substrate and/or the passivation layer before the polymer layer is coupled to the optical layer. In some embodiments, the polymer layer is coupled to the optical layer before the polymer layer is coupled to the substrate and/or the passivation layer. In some embodiments, forming the microfluidic inlet comprises etching the optical layer. For example, laser drilling the optical layer to form the inlet. In some embodiments, the optical layer is a glass substrate. In some embodiments, the optical layer is at least semitransparent to allow for optical sensing of the microfluidic channel. For example, the piezoelectric structures and performance can be monitored through the optical layer.

In some embodiments, forming the microfluidic inlet comprises removing a portion of the substrate (e.g., the inlet is formed through the substrate instead of the optical layer). In some embodiments, the polymer layer is configured to converge the channel to a sense region to allow for high signal-to-noise ratio (SNR) for broad spectrum, high frequency sensing and then diverge the channel to align with an ejection actuation zone design.

In some embodiments, a polymer microfluidic layer is spin coated or laminated on glass, then the polymer layer is photo imaged and developed. Afterwards, it is aligned to the sensors and the piezoelectric actuators on silicon. Then it is fully baked under pressure to form the laminate composite structure.

(C2) In some embodiments of C1, the substrate comprises a BOX layer (e.g., the BOX layer 210) that separates a base layer (e.g., the handler layer 212) and a device layer (e.g., the device layer 208), and the set of piezoelectric actuators are placed on the device layer. For example, the base layer may have a thickness of 450 μm, the BOX layer may have a thickness of 1 μm, and the device layer may have a thickness of 3 μm.

(C3) In some embodiments of C1 or C2, placing the set of piezoelectric actuators includes: (i) depositing a bottom electrode layer (e.g., the bottom electrode 224) on the substrate; (ii) depositing a piezoelectric material (e.g., the piezoelectric layer 228) on the bottom electrode layer; and (iii) depositing a top electrode layer (e.g., the top electrode 230) on the piezoelectric material. In some embodiments, placing the set of piezoelectric actuators further includes etching an electrode pattern in the top electrode layer; etching an actuator pattern in the piezoelectric material; and etching an electrode pattern in the bottom electrode layer.

(C4) In some embodiments of any of C1-C3, forming the outlet channel includes forming a microfluidic outlet (e.g., the outlet 218), where a diameter of the microfluidic outlet is less than a diameter of the outlet channel. For example, the microfluidic outlet may have a diameter of 50 μm or less and the outlet channel may have a diameter of 300 μm or more.

(C5) In some embodiments of any of C1-C4, coupling the polymer layer to the optical layer includes applying a polymer spin coat to the optical layer. For example, the polymer may be applied in a pattern using a mask. In some embodiments, the polymer layer is spun coated, exposed, and developed to form the microfluidic channel. In some embodiments, the polymer layer is laminated on the optical layer.

(C6) In some embodiments of any of C1-C5, placing the passivation layer on the set of piezoelectric actuators comprises depositing the passivation layer. As an example, the passivation layer has a thickness in the range of 0.01 μm-1 μm.

(C7) In some embodiments of any of C1-C6, the method further includes placing a set of electrodes (e.g., the electrodes 222) in, or adjacent to, the microfluidic channel. In some embodiments, placing the set of electrodes comprises patterning and etching the passivation layer.

It will be understood that, although the terms first, second, etc. may be used herein to describe various elements, these elements should not be limited by these terms. These terms are only used to distinguish one element from another. For example, a first array could be termed a second array, and, similarly, a second array could be termed a first array, without departing from the scope of the various described embodiments. The first array and the second array are both arrays, but they are not the same array.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A microfluidic device, comprising:
a substrate having an outlet channel;
a microfluidic channel arranged on the substrate such that an outlet of the microfluidic channel is positioned above at least a portion of the outlet channel; and
a set of piezoelectric actuators arranged above the outlet channel and adjacent to the outlet, the set of piezoelectric actuators configured to eject a portion of a fluid out of the microfluidic channel via the outlet.

2. The microfluidic device of claim 1, wherein the outlet includes a hole that is formed through a thickness of the set of piezoelectric actuators and enclosed by the set of piezoelectric actuators.

3. The microfluidic device of claim 1, wherein the set of piezoelectric actuators are arranged on a membrane above the outlet channel.

4. The microfluidic device of claim 1, further comprising a passivation layer arranged between the set of piezoelectric actuators and the microfluidic channel.

5. The microfluidic device of claim 1, further comprising a first electrode and a second electrode, wherein the first electrode and the second electrode are configured to provide actuation signals to the set of piezoelectric actuators, wherein the set of piezoelectric actuators are positioned between the first electrode and the second electrode.

6. The microfluidic device of claim 1, further comprising an optical layer, wherein the microfluidic channel is arranged between the optical layer and the substrate.

7. The microfluidic device of claim 1, further comprising a polymer layer that defines at least a portion of the microfluidic channel.

8. The microfluidic device of claim 1, further comprising one or more electrodes arranged adjacent to the microfluidic channel and configured to apply an electrical field to the fluid.

9. The microfluidic device of claim 1, wherein the substrate includes a silicon base layer and a buried oxide (BOX) layer, wherein the BOX layer separates the microfluidic channel from the silicon base layer.

10. The microfluidic device of claim 1, further comprising a second set of piezoelectric actuators arranged adjacent to an inlet of the microfluidic channel.

11. The microfluidic device of claim 1, further comprising control circuitry electrically coupled to the set of piezoelectric actuators and configured to provide actuation signals to the set of piezoelectric actuators.

12. A method, comprising:
providing a plurality of particles through a microfluidic channel having an outlet positioned above at least a portion of an outlet channel;
manipulating, with a set of electrodes, the particles flowing through the microfluidic channel with an electrical field; and
ejecting, with a set of piezoelectric actuators located adjacent to the outlet and above the outlet channel, a portion of a fluid in the microfluidic channel.

13. The method of claim 12, further comprising:
providing actuation signals to the set of piezoelectric actuators; and
providing actuation signals to the set of electrodes.

14. A method of constructing a microfluidic device, comprising:
placing a set of piezoelectric actuators on a substrate;
placing a passivation layer on the set of piezoelectric actuators;
forming an outlet channel by removing a portion of the substrate below the set of piezoelectric actuators;
coupling a polymer layer to an optical layer;
forming a microfluidic inlet by removing a portion of the optical layer; and
forming a microfluidic channel between the microfluidic inlet and the outlet channel by coupling the optical layer to the substrate via the polymer layer.

15. The method of claim 14, wherein the substrate comprises a BOX layer that separates a base layer and a device layer, and wherein the set of piezoelectric actuators are placed on the device layer.

16. The method of claim 14, wherein placing the set of piezoelectric actuators comprises:
depositing a bottom electrode layer on the substrate;
depositing a piezoelectric material on the bottom electrode layer; and
depositing a top electrode layer on the piezoelectric material.

17. The method of claim 14, wherein forming the outlet channel includes forming a microfluidic outlet, wherein a diameter of the microfluidic outlet is less than a diameter of the outlet channel.

18. The method of claim 14, wherein placing the polymer layer on the optical layer comprises applying a polymer spin coat on the optical layer.

19. The method of claim 14, wherein placing the passivation layer on the set of piezoelectric actuators comprises depositing the passivation layer.

20. The method of claim 14, further comprising placing a set of electrodes in, or adjacent to, the microfluidic channel.
